(19) United States
(12) Patent Application Publication
(10) Pub. No.: US 2009/0058910 A1
(43) Pub. Date: Mar. 5, 2009

(54) Image Forming Method, Image Forming Apparatus, and Image Forming Program and Recording Medium

(76) Inventors: Shinichi Hatanaka, Tokyo (JP); Masanori Hirano, Kanagawa (JP); Takashi Kimura, Kanagawa (JP); Masakazu Yoshida, Kanagawa (JP)

Correspondence Address: IPUSA, P.L.L.C, 1054 31ST STREET, N.W., Suite 400, Washington, DC, 20007, US

(21) Appl. No.: 12/194,627

(22) Filed: Aug. 20, 2008

(30) Foreign Application Priority Data
Sep. 4, 2007 (JP) 2007-229440

(51) Int. Cl. B41J 2/205

(52) U.S. Cl. 347/15

(57) ABSTRACT

An image forming method provided with the steps of: (a) providing a plurality of first nozzles for depositing a black color ink and a plurality of second nozzles for depositing color inks other than a black color ink to form a processed black color, the first nozzles and the second nozzles being mounted on a recording head of an image forming apparatus scanning relative to a recording medium in a first direction, the first nozzles shifted relative to the second nozzles in a second direction perpendicular to the first direction; (b) scanning the recording head in a first direction; (c) while scanning the recording head in the first direction, for printing a black image, depositing the black color ink by the first nozzles onto a first recording position of the recording medium and depositing the color inks by the second nozzles onto a second recording position of the recording medium.

### BACKGROUND OF THE INVENTION

1. Field of the Invention

The present invention relates to an image forming method, an image forming apparatus, an image forming system, and a recording medium including an image forming method program.

2. Description of the Related Art

Conventionally, inkjet recording apparatuses utilizing an inkjet recording method are known. The inkjet recording apparatuses can record high quality images at relatively low cost and are increasingly used as output apparatuses for color image forming with the spread of personal computers in the market place.

An inkjet recording head of an inkjet recording apparatus includes plural nozzles arranged along a sub-scan direction (paper feed direction) and is caused to scan in a main-scan direction (perpendicular to the paper feed direction) by a carriage mechanism. The nozzles jet ink droplets with timings according to dot pattern data decoded from recording data. Thereby, ink droplets from the individual nozzles are deposited on a recording medium (a paper), so that printing is performed.

Such an inkjet recording apparatus is used for an output apparatus of a personal computer, and it is required for the inkjet recording apparatus to perform high speed printing (operation), and have high quality, a compact design, and low cost. High speed operation can be achieved by increasing the frequency of inkjet driving and the number of nozzles, and also be achieved by printing at low resolution, even in an environment where the image resolution is higher than the nozzle resolution (pitch). Further increase in image quality may be achieved by refining the dot size and performing higher resolution printing.

As an approach to achieve both high speed and high quality images for printing, increasing the number of nozzles with fine dots being used, but there are disadvantages in that the inkjet recording head becomes bigger and the cost increases with the number of nozzles. Further, increasing the size of the recording head brings increases in the size of the inkjet record apparatus, its vibration and noise while driving the recording head, and power consumption. In short, there is a trade off issue between an increase in the nozzles and miniaturization of the inkjet recording apparatus.

For a method to meet both high speed and high quality image requirements for printing without an increase in the number of nozzles, there is a technique that modifies the arrangement of the nozzles in the head to increase a pseudo-resolution of images (e.g. patent documents 1, 2 and 3). This technique provides nozzles of the three primary colors (magenta, cyan, yellow) shifted a half (½) pitch relative to the black ink nozzles in the same scan line. When monochrome data are recorded, a black color of the black ink and a process black obtained by using a mixture of the three color inks are used together, achieving double resolution for a monochrome recording without reducing recording (printing) speed.

Further, as another type of inkjet recording apparatus, there is a line head type which includes an inkjet recording head configured to have a long shape to approximately correspond to the maximum print width of a recording medium and fixed on the body of the recording apparatus. According to this configuration, a main scan by the inkjet recording head is not necessary, and the printing is performed by just transporting a recording medium in the sub-scan direction, which is perpendicular to the main-scan direction, so that high speed image formation can be performed.

Such an inkjet recording apparatus can also be provided with nozzles of the three primary colors (magenta, cyan, yellow) shifted a half (½) pitch relative to the pitch of black ink nozzles in the identical scan line, and used with a double resolution for a monochrome recording without reducing recording (printing) speed when monochrome data are recorded.

Patent document 1: Japanese Patent Application Publication H02-026753

Patent document 2: Japanese Examined Patent Application Publication Patent Number 3533771

Patent document 3: Japanese Patent Application Publication 2001-171153

However, the process black (process black imaging) formed by a mixture of the color ink has a lower concentration of black compared to the black ink alone. This is because a dominant color varies with the deposited order of ink. When a first ink droplet is deposited on a recording medium and a second ink droplet is deposited on the first ink droplet, the second ink droplet tends to penetrate deeper into the medium than the first ink droplet at a zone where the first and second ink droplets overlap.

For monochrome (gray) printing, as the concentration is a key factor in determining the image quality, lowering the concentration of color is not preferred even if a high resolution is obtained.

The present invention takes into consideration the issues described above. An image forming method, an image forming apparatus, an image forming system, and an image forming program recorded in a medium are provided for use with both high speed and high concentration when black color is formed by inks other than black ink.

### SUMMARY OF THE INVENTION

According to one aspect of the present invention, an image forming method, an image forming apparatus, an image forming system, and an image forming program recorded in a medium may be provided for use with both high speed and high concentration when black color is formed by inks other than a black ink.

According to another aspect of the invention includes an image forming method includes the steps of: (a) providing a plurality of first nozzles for depositing a black color ink and a plurality of second nozzles for depositing color inks other than a black color ink to form a processed black color, the first nozzles and the second nozzles being mounted on a recording head of an image forming apparatus scanning relative to a recording medium in a first directions the first nozzles being shifted relative to the second nozzles in a second direction perpendicular to the first direction; (b) scanning the recording head in the first direction; and (c) while scanning the recording head in the first direction, for printing a black image, depositing the black color ink by the first nozzles onto a first recording position of the recording medium and depositing the color inks by the second nozzles to form the processed black color onto a second recording position of the recording medium so that the black color ink deposited onto the first recording position is shifted relative to the color inks deposited to form the processed black color onto the second recording position, wherein the order of depositing the color inks onto the second recording position is based on a predetermined index indicating a difference between the processed black color formed by the color inks and the black color of the black color ink or between the processed black color formed by the color inks and a reference achromatic color.

According to another aspect of the invention, an image forming apparatus includes a first nozzle depositing a black color ink; a set of second nozzles depositing plural color inks other than the black color ink to form a processed black color; a recording head including the first nozzle and second nozzle and scanning in a first direction; and the first nozzle and the second nozzles being shifted relative to each other in a second direction perpendicular to the first direction; wherein for printing a black image, while the recording head scans once in the first direction, the black color ink is deposited on a first recording position of a recording medium by the first recording nozzle and each color of the second nozzles is deposited on a second recording position of the recording medium to form the processed black color by the corresponding second nozzle, wherein the order of depositing the inks of the second nozzles is determined based on a predetermined index indicating a difference between the processed black color formed by the color inks and the black color of the black color ink or between the processed black color formed by the color inks and a reference achromatic color.

According to another aspect of the invention, an image forming system includes an image forming apparatus including a first nozzle depositing a black color ink, a set of second nozzles depositing plural color inks other than a black ink to form a processed black color, and a recording head including the first nozzle and the second nozzles and scanning in a first direction, wherein the first nozzle and the second nozzles are shifted relative to each other in a second direction perpendicular to the first direction; and a computer capable of requesting the image forming apparatus to print an image; wherein for printing a black image, while the recording head scans once in the first direction perpendicular to the second direction, the black color ink is deposited onto a first recording position of a recording medium by the first recording nozzle and each color of the second nozzles is deposited to form the processed black color onto a second recording position of the recording medium by the corresponding second nozzles, wherein the order of depositing the inks of the second nozzles is determined based on a predetermined index indicating a difference between the processed black color formed by the color inks and the black color of the black color ink or between the processed black color formed by the color inks and a reference achromatic color.

According to another aspect of the invention, a computer-readable recording medium having executable instructions therein which, when executed by a computer, performs the steps of: (a) providing a recording medium for forming an image using an image forming apparatus having a recording head including a plurality of first nozzles for depositing a black color ink and a plurality of second nozzles for depositing color inks other than black ink to form a processed black color; (b) scanning the recording head in a first direction; and (c) while scanning the recording head in the first direction, for printing a black image, depositing the black color ink by the first nozzles onto a first recording position of the recording medium and depositing the color inks by the second nozzles to form the processed black color onto a second recording position of the recording medium so that the black color ink that is deposited onto the first recording position is shifted relative to the color inks that are deposited onto the second recording position in a second direction perpendicular to the first direction, wherein the order of depositing the color inks onto the second recording position is based on a predetermined index indicating a difference between the processed black color formed by the color inks and the black color of the black color ink or between the processed black color formed by the color inks and a reference achromatic color.

According to another aspect of the invention, an image forming method may provide when a resolution of an input image is different from the resolution of the recording head using both the first nozzle and the second nozzles, the resolution of the input image is adjusted to the resolution of the recording head.

According to another aspect of the invention, an image forming system includes an image forming apparatus including a first nozzle depositing a black color ink, a set of second nozzles depositing plural color inks other than a black ink to form a processed black color, and a recording head including the first nozzle and the second nozzles and scanning in a first direction, wherein the first nozzle and the second nozzles are shifted relative to each other in a second direction perpendicular to the first direction; and a computer capable of requesting the image forming apparatus to print an image; wherein for printing a black image, while the recording head scans once in the first direction perpendicular to the second direction, the black color ink is deposited onto a first recording position of a recording medium by the first recording nozzle and each color of the second nozzles is deposited to form the processed black color onto a second recording position of the recording medium by the corresponding second nozzles, wherein the order of depositing the inks of the second nozzles is determined based on a predetermined index indicating a difference between the processed black color formed by the color inks and the black color of the black color ink or between the processed black color formed by the color inks and a reference achromatic color.

Other objects, features and advantages of the present invention will become more apparent from the following detailed description when read in conjunction with the accompanying drawings.

### BRIEF DESCRIPTION OF THE DRAWINGS

FIG. 1 is a perspective illustration showing a configuration of a color inkjet recording apparatus of an embodiment of the present invention;

FIG. 2 shows an example configuration of a head unit mounted on a color inkjet recording apparatus according to an embodiment of the present invention;

FIG. 3 is an example showing a nozzle arrangement of a head unit of a color inkjet recording apparatus according to an embodiment of the present invention;

FIG. 4 is an illustration to show a head unit operation for bidirectional printing on a recording medium;

FIG. 5 is an illustration showing a coloring material distribution in the recording medium after color inks impact on the same zone;

FIG. 6 is an illustration showing an example of a dominant color and subordinate colors for a process black during a single direction scan according to the arrangement of color heads according to an embodiment of the present invention;

FIG. 7 is an illustration showing an example of a dominant color and subordinate colors for a process black according to an arrangement of color heads when a line head is used;

FIG. 8 shows an example of a colorimetric value distribution of CMYK inks on an a*b* plane in a L*a*b* color space;

FIG. 9 shows an example of a colorimetric value distribution of mixed color dots for different impact orders of CMY inks on an a*b* plane in a L*a*b color space;

FIG. 10 is a first illustration showing an example of a head unit according to the present embodiment;

FIG. 11 is a second illustration showing an example of a head unit according to the present embodiment;

FIG. 12 is an illustration showing an example of the recording position of black ink dots for a serial head method;

FIG. 13 is a third illustration showing an example of a head unit according to the present embodiment;

FIG. 14 is an illustration showing an example of the process adding a single dot of an adjacent pixel to a fine line one dot thick;

FIG. 15 is an illustration to show an example of a determination method which determines whether a line is a single dot thick according to the font information of input data;

FIG. 16 is an illustration to show an example of a determination method which determines whether a line is a single dot thick according to the vector information of input data;

FIG. 17 shows an example of down-converting the resolution of an input image according to the recording resolution of a head unit; and

FIG. 18 shows an example of up-converting the resolution of an input image according to the recording resolution of a head unit.

### DETAILED DESCRIPTION OF THE PREFERRED EMBODIMENTS

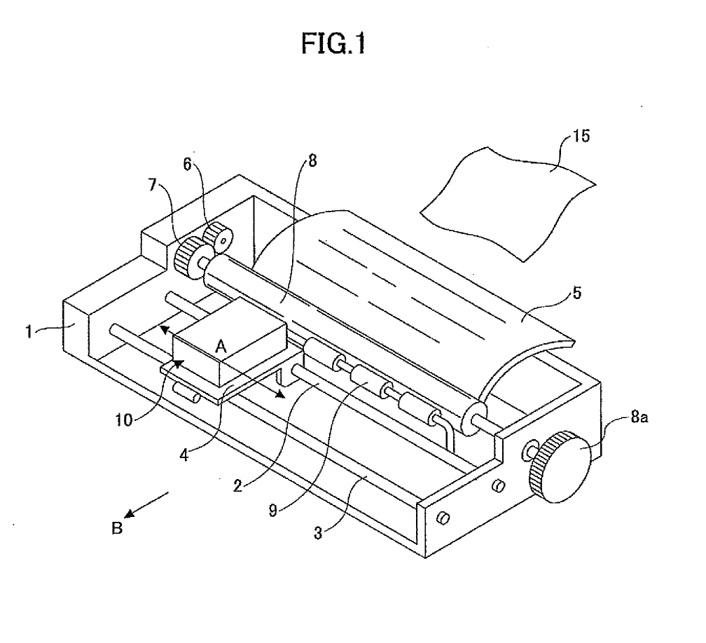

In the following, the embodiments of the present invention are described with reference to the figures. FIG. 1 is a perspective illustration showing a configuration of a color inkjet recording apparatus of an embodiment of the present invention.

In FIG. 1, a color inkjet recording apparatus 100 is provided with a frame 1, a guide rail 2, a guide rail 3, a carriage 4, a guide plate 5, a drive gear 6, a sprocket gear 7, a platen 8, a send knob 8a, pressure rollers 9, and a head unit 10 (a recording head). In the figure, a recording paper 15 (recording medium, or recording sheet) is shown.

For the color inkjet recording apparatus 100, the carriage 4 is movably mounted on the guide rails 2 and 3 which are horizontally laid on the frame 1. The head unit 10 is mounted on the carriage 4. The carriage 4 moves with a drive mechanism such as a motor or the like (not shown) along the guide rails 2 and 3 in directions of the arrow A.

The recording paper 15 set on the guide plate 5 is taken by the platen 8, which includes the knob 8a rotating via the sprocket gear 7 and the drive gear 6 driven by a driver (not shown), and transported in the arrow B direction through the body of the platen 8 and the pressure roller 8 pressing the platen 8.

The color inkjet recording apparatus 100 prints images on the recording paper 15 from above by jetting ink droplets from the head unit 10 while scanning the head unit 10 in the main-scan direction (A direction) and sending the recording paper 15 in the sub-scan direction (B direction).

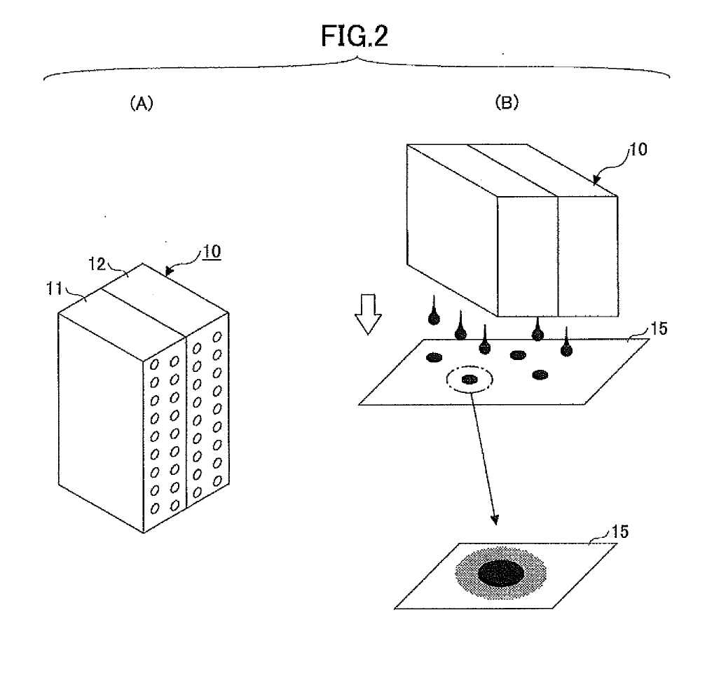

FIG. 2 shows an example configuration of a head unit mounted on a color inkjet recording apparatus according to an embodiment of the present invention. In FIG. 2(A), the head unit 10 is configured by jet units 11 and 12 each containing color inks. The head unit 10 records by jetting (depositing) ink droplets on a surface of the paper (recording medium) 15. The jet units 11 and 12 each includes plural inkjet nozzles, and are able to jet ink droplets (color inks) having plural sizes with differing volumes. Further, FIG. 2(B) shows how the ink droplets jetted (deposited) from the head unit 10 are recorded on the recording paper 15 from above.

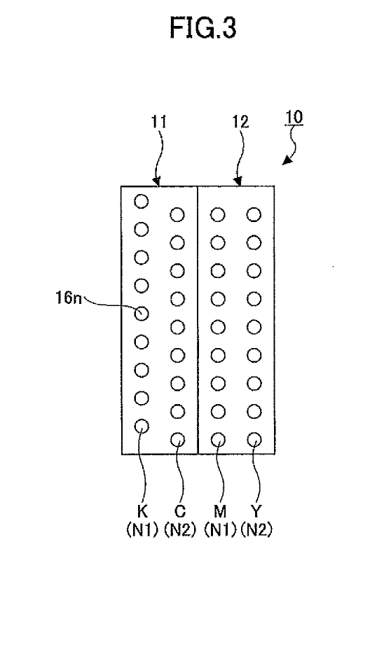

FIG. 3 shows is an example showing a nozzle arrangement of a head unit of a color inkjet recording apparatus according to an embodiment of the present invention. As shown in FIG. 3, the jet units 11 and 12 configuring the head unit 10 include plural nozzles 16n in rows N1 and N2 which rows are arranged along the main-scan direction to jet ink droplets perpendicular to the main-scan direction. Further, the nozzle row K (N1) jetting black ink is shifted ½ pitch (a half nozzle pitch) in the sub-scan direction relative to the nozzles 16n of the other nozzle rows.

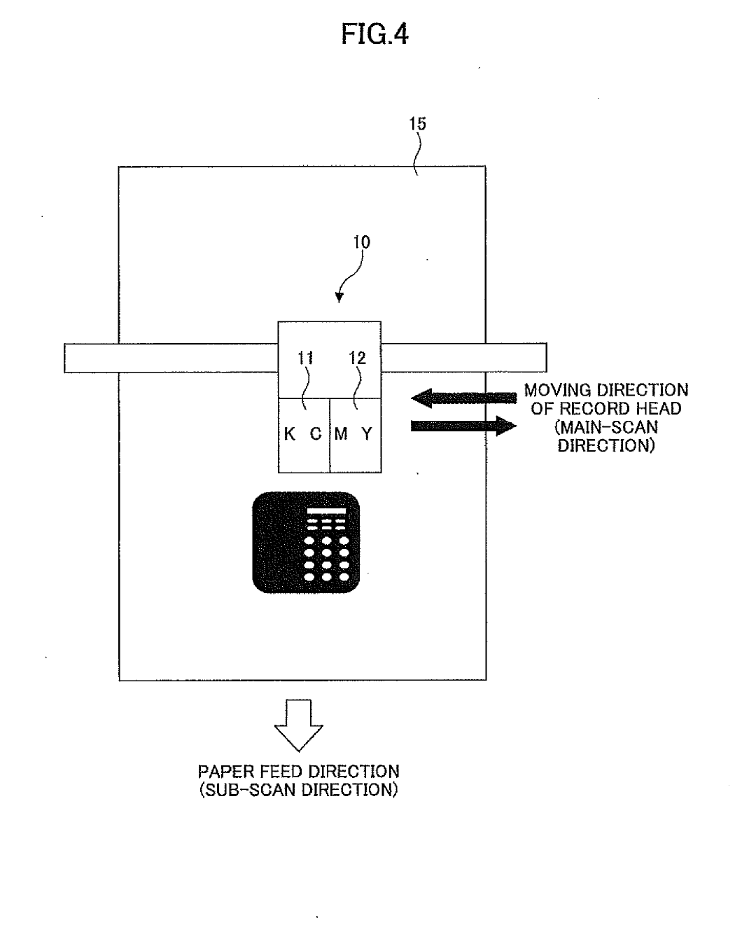

FIG. 4 is an illustration to show a head unit operation for bidirectional printing on a recording medium. The head unit 10 includes the jet units 11 and 12 that are arranged with colors in order of recording (depositing), that is, black, cyan, magenta, and yellow (indicated as K, C, M, and Y in the following) along the main-scan (first) direction. The color inkjet recording apparatus 100 operates the head unit 10 having the above features by scanning it left-and-right in the main-scan direction, and prints (jets ink droplets from the nozzles) bidirectionally while scanning the head unit 10 left and right in the main-scan direction. Further, the order of colors and the number of the colors of the head unit 10 are not limited to the present embodiment. For example, according to the characteristics of ink, design choice or the like, different orders of colors or more colors may be used. Further, other mixing color combinations, such as R (red), G (green), and B (blue) may be used to form black. Further, a pattern to create black may be chosen from plural combinations of inks mounted on the head unit 10. For example, when inks K, C, M, Y, R, G, and B are mounted, there are plural combinations to obtain black such as CMY, RGB, RC, GM, BY and the like.

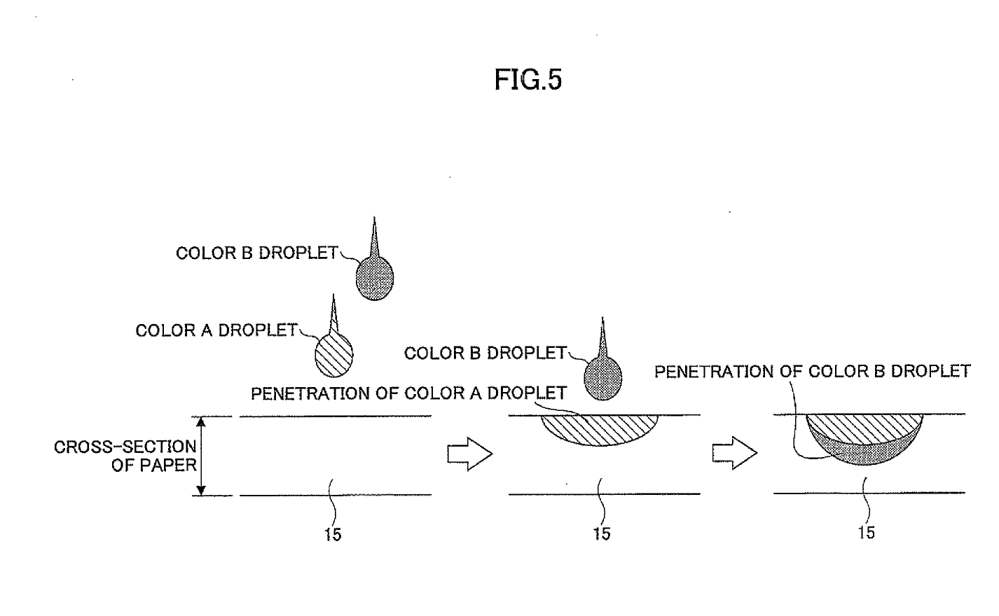

FIG. 5 is an illustration showing a coloring material distribution in the recording medium 15 after color inks impact the same zone. A cross section of the recording paper 15 is shown in the figure.

As shown in FIG. 5, the coloring material contained in a first ink droplet that impacted (a droplet of a color A droplet in the present example) before a second ink droplet (a color B droplet in the present example) stays on the surface of a paper and the second ink droplet that impacted after the first ink droplet penetrates into the inner part of the paper. As a result, the coloring material dominates at the record plane of the recording paper 15 and the color A first impacting becomes a dominant color. Such a color fixation characteristic tends to be stronger for a pigment based ink indicated in the present embodiment than for a dye based ink.

Therefore, it is necessary to take into consideration the change in the concentration and color tone of inks caused by the order of overlapping colors when plural color inks are used to record (deposit) with positions or impacts on the same position (zone) to create black by using a process black (process black imaging). Especially, when a bidirectional recording is planned for increasing the print speed, the dominant color in printing (depositing) changes while scanning the head unit in the outward direction compared to in the return direction and improper concentrations and improper color tones may be caused for black formation.

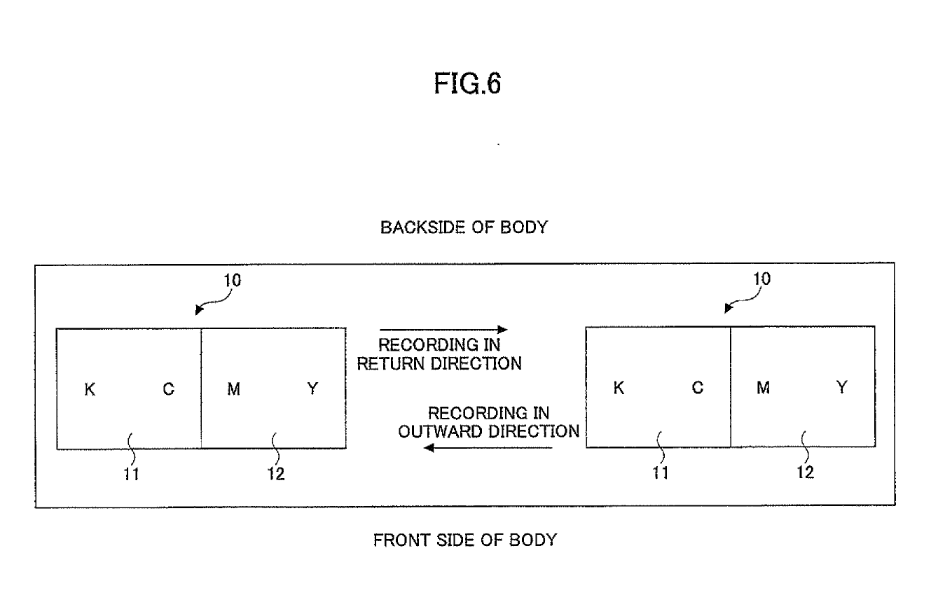

FIG. 6 is an illustration showing an example of a dominant color and subordinate colors for a process black during a single direction scan according to the arrangement color heads according to an embodiment of the present invention. FIG. 6 indicates the dominance for color components in the process black imaging. A predicted dominant strength of color inks is shown for scanning the head unit 10 in the outward direction (in this case, the inks are jetted in the order of CMY) to deposit (record) on the recording paper 15 and for scanning the head unit 10 in the return direction (in this case, the inks are jetted in the order of YMC) to deposit (record) on the recording paper 15. Further, the following relations (referred to indexes) are expediently simplified for description.

The predicted dominant strength of color inks are:

Recording during a scan outward: C>M>Y (1)

Recording during a scan to return: Y>M>C (2)

Further, for bidirectional recording, that is, when the recording is performed in the outward direction and the return direction, the relations (1) and (2) are maintained for the dominant color and the subordinate colors.

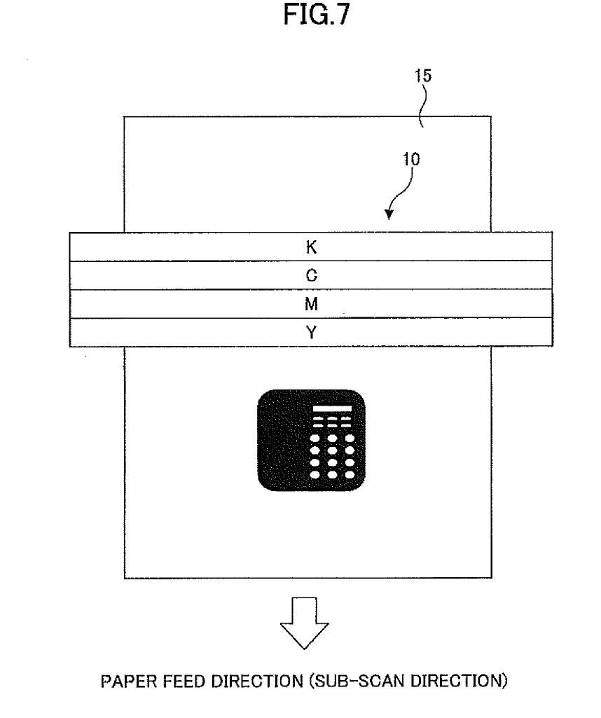

Further, the above has been described for the case where the head unit 10 is a serial head type. The head unit 10 of a line head type may be used. FIG. 7 is an illustration showing an example of a dominant color and subordinate colors for a process black according to an arrangement of respective color heads when a line head is used.

When the line heads are used for the head unit 10, as shown in FIG. 7, the order of overlap of the color inks is determined in a unique manner according to the order of the arrangement of colors and the paper feed direction. Thus, when the individual color recording heads are arranged to be KCMY in the sub-scan direction, the inks are always overlapped in the order of CMY with regard to the process black as shown in FIG. 7. In this case, the dominant strength of color inks is expressed in the following relation (index). Further, the relation is simplified for explanation.

Predicted dominant strength: C>M>Y (3)

Further, the dominant strength is maintained for a zone where the inks are overlapped and this is effective not only for the inks impacting on the same position but for a zone where the impacted ink and ink spreading from another impacted position are overlapped.

For the process black, it is important to use an ink having a strong dominance of color to obtain a proper concentration and color tone for the black. However, a method to determine an ink as a dominant color with high concentration black may be dependent on the configuration of the head unit 10 (serial head type or line head type) and the recording type (single direction recording or bidirectional recording), thus the method is described with respect to the recording types of the head unit 10.

First, the method is described for a case where the single recording type is taken for the color inkjet recording apparatus 100 or a line head is used for the head unit 10. In the present case, the order of overlap of inks is determined to be unique by the arrangement of nozzles. Thus, it is necessary to determine an arrangement of the inkjet nozzles to obtain a proper concentration and color tone of the process black. Then, in the present embodiment, for example, an ink having high concentration black is used as a dominant color based on taking into consideration that it is effective to create high concentration black by using the process black. When there are three colors C, M, and Y, C or M having a relatively higher concentration of black may be caused to impact the recording paper first, and last, Y having a relatively lower black concentration may be caused to impact. The black concentration is determined by a colorimetric value obtained by measuring an ink with a black concentration measurement filter. Each ink has a black concentration, and for example, the black concentration of the ink K is relatively high and that of the ink Y is relatively low.

Further, an ink having a small color distance from an ideal black is used as a dominant color taking into consideration that it is effective to create high concentration black by using the process black. When there are three colors C, M, and Y, for example, C or M having a relatively small color difference (distance) from black, may impact the recording paper first, and last, Y being relatively farthest from ideal black may impact. The “ideal black” may be recorded (deposited) by a black ink or black (gray) in individual color spaces. Further, the individual color distances between black (gray) or black ink and C, M and Y are calculated by the following equations (indexes).

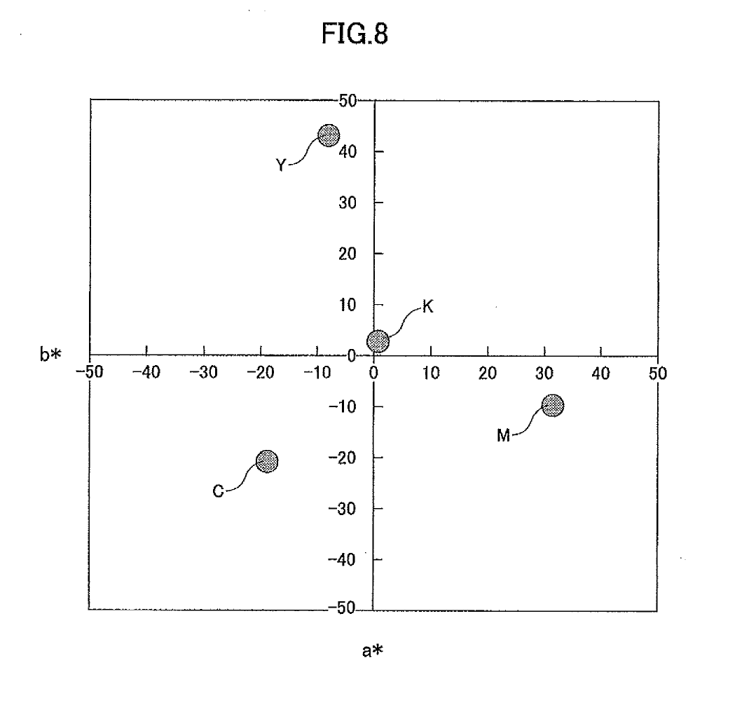

FIG. 8 shows an example of a colorimetric value distribution of CMYK inks on an a*b* plane in a L*a*b* color space, where L* (not shown) is included in the following definitions.
For colorimetric values of the ink C, the component L* is denoted as Cl, the component a* is denoted as Ca, and the component b* is denoted as Cb;
for colorimetric values of the ink M, the component L* is denoted as Ml, the component a* is denoted as Ma, and the component b* is denoted as Mb;
for colorimetric values of the ink Y, the component L* is denoted as Yl, the component a* is denoted as Ya, the component b* is denoted as Yb.
The color distance between the ink C and the black (gray) is denoted as ΔEc;
the color distance between the ink M and the black (gray) is denoted as ΔEm; and
the color distance between the ink Y and the black (gray) is denoted as ΔEy.

The color distances between the respective inks C, M and Y and the black (gray) in the color space L*a*b* are obtained by the following corresponding equations.

ΔEc=sqrt(Cl²+Ca²+Cb²),

ΔEm=sqrt(Ml²+Ma²+Mb²),

ΔEy=sqrt(Yl²+Ya²+Yb²) (4).

Further, for calorimetric values of the ink K, the component L* is denoted as Kl, the component a* is denoted as Ka, and the component b* is denoted as Kb.
The color distance between the ink C and the ink K is denoted as ΔEck;
the color distance between the ink M and the ink K is denoted as ΔEmk; and
the color distance between the ink Y and the ink K is denoted as ΔEyk.

The color distances between the respective inks C, M and Y and the ink K are obtained by the following corresponding equations.

ΔEck=sqrt{(Cl−Kl)²+(Ca−Ka)²+(Cb−Kb)²)},

ΔEmk=sqrt{(Ml−Kl)²+(Ma−Ka)²+(Mb−Kb)²)},

ΔEyk=sqrt{(Yl−Kl)²+(Ya−Ka)²+(Yb−Kb)²)} (5)

When an ink head capable of controlling the ink droplet size is used, gray balance may be adjusted by controlling the color ink droplet size. For example, the ink initially impacting has black concentration and tone close to the ideal black. The other inks following the initial ink may be a greater distance, then the last ink to impact may have equal or less volume of the ink droplet.

Next, a method is described for a bidirectional recording type color inkjet recording apparatus 100. In the present case, the order of overlapping inks is reversed between the outward scan and return scan. Therefore, although process black imaging is performed with a black concentration and tone close to those of the ideal black in the outward scan direction, there can be a large difference between the process black imaging for the outward scan and that for the return scan, which has the reverse order of the ink impacts and ink overlaps. In this case, the color difference (distance) of the process black between the outward scan and the return scan can be easily noticed, and can result in poor image quality.

Thus, in the present embodiment, the arrangement of individual inkjet nozzles and the amount of the ink droplets are controlled in order to reduce the color difference (color distance) between the process black in the outward scan direction and another process black in the return scan direction, and to achieve a proper concentration and color tone for the process black. The color difference of the process black for two different ink impact orders, one in the outward scan and one in the return scan, is calculated by the equations described below.

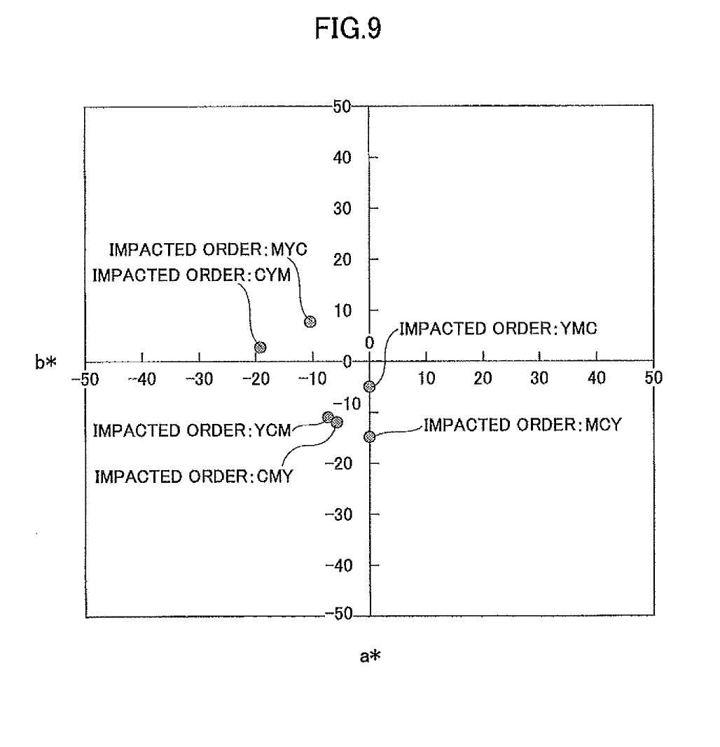

FIG. 9 shows an example of a calorimetric value distribution of mixed color dots for different impact orders of CMY inks on an a*b* plane in the L*a*b color space. In mixed dots, when a reverse overlap order of inks and the color difference are obtained, the component L* of an arbitrary mixed color dot F is denoted as Fl, the component a* is denoted as Fa, and the component b* is denoted as Fb. The component L* of a mixed color dot G for the reverse overlap order of the inks is referred to as Gl, the component a* is referred to as Ga, and the component b* is referred to as Gb. The color difference between F and G, ΔEfg is calculated by the following equation.

ΔEfg=sqrt{(Fl−Gl)²+(Fa−Ga)²+(Fb−Gb)²} (6)

Further, the component L* of an arbitrary mixed color dot H is denoted as Hl, the component a* is referred to as Ha, and the component b* is referred to as Hb. The color distance between the mixed color dot H and the black (gray) in the color spaces L*a*b* is obtained by the following equation.

ΔEh=sqrt(Hl²+Ha²+Hb²) (7)

Further, the color distance (difference) ΔEhk between an arbitrary mixed color dot H and the ink K is obtained in the following equation.

ΔEhk=sqrt{(Hl−Kl)²+(Ha−Ka)²+(Hb−Kb)²} (8)

Further, for bidirectional recording, as in the case of single direction recording, it is considered effective to use an ink having a color tone close to that of the ideal black as a dominant color for creating a process black image that is close to the tone of the ideal black. For an outward scan or return scan, it may be preferable that, when there are three colors C, M, and Y, C or M, having relatively close color tone of the ideal black should impact on the recording paper first, and last, Y having relatively farthest tone from the ideal black should impact last. Therefore, ink C or M, which has a relatively high black concentration, is caused to impact first, and ink C having lowest black concentration is impacted last. Further, ink C or M having relatively close color difference to black may be impacted first, and ink Y having a large color difference (distance) with black may be caused to impact last. In the present process, an ink impacting first improves the concentration and tone of the process black, and the ink impacting last degrades the concentration and tone of the process black. Thus the ink impacting last may be controlled to have equal or less amount of ink in its droplet compared to the amount of ink in the droplets of the other color inks.

The order of ink overlap for the return scan becomes opposite to that for the outward scan. When the ink C or M having a color tone close to the ideal black impacts first and the ink Y having a color tone farthest from the ideal black impacts last for the outward scan (or the return scan), then the ink Y having a color tone farthest from the ideal black impacts first and the ink C or M having a color tone close to the ideal black impacts last for the return scan (or the outward scan).

When a first ink of the process black impacts on a recording paper in advance of a second Ink of the process black, the concentration and color tone of the first ink should be separated from the concentration and color tone of the ideal black greater than those of the second ink of the process black, and the concentration and color tone of the second ink of the process black should be closer to the concentration and color tone of the ideal black than to those of the first ink. The amount of the first ink droplet of the process black should be equal or smaller than the amount of the second ink droplet of the process black, in which the second ink impacts on the recording medium after the first ink. As a result, the color distance (difference) between the process black while scanning outward and while scanning in return can be maintained to be small.

Further, no matter whether the single direction recording, the bidirectional recording or the line head recording is used, a black dot of the process black formed by overlapping plural color inks tends to be unclear (oozed) compared to the dot formed by only black ink. Further, it is difficult to achieve a perfect black (achromatic color) with respect to the concentration and the color tone, and the ink includes some amount of color.

Then, the color inks of the process black may be less than a proper amount of the black ink to make the black dots of the black ink clearer than the process black.

Further, the ink size control range includes a case where no ink impacts. When the process black dot stands out even when controlling the ink droplet size for such as the edge of a monochrome image, having no ink impact may be chosen to avoid degradation of the image quality due to the process black dots.

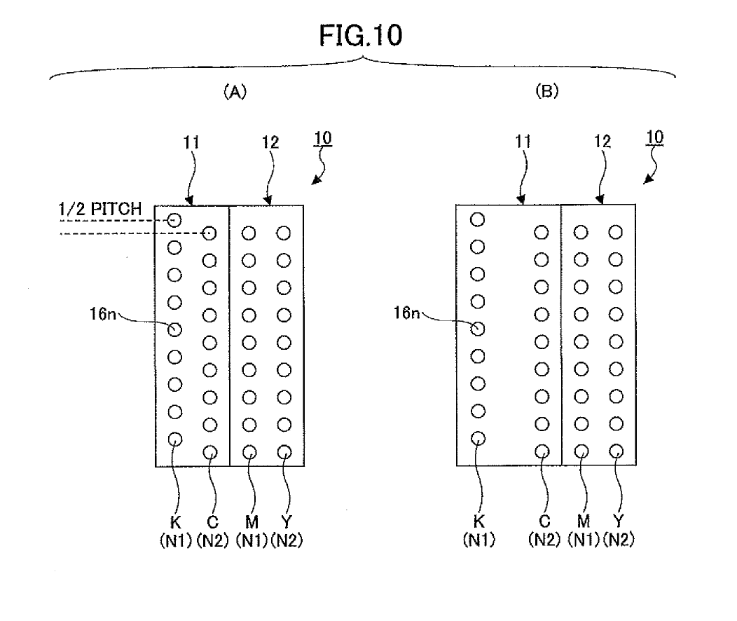

Next, another variation is described in detail for a head unit of the color inkjet recording apparatus 100 according to the present embodiment. FIG. 10 is a first illustration showing an example of a head unit according to the present embodiment. In FIG. 10, color nozzle rows N1 and N2 of a head unit 10 that is a serial head type are arranged in the main-scan direction. In the example, the nozzle row K (N1) jetting black ink is arranged shifted in the sub-scan direction by ½ pixel pitch (a half pitch) compared to the rows of plural color ink nozzles C, M, and Y. In FIG. 10(A), the nozzle rows are arranged at an equal separation. In FIG. 10(B), the distance between the nozzle row K and the nozzle row C is relatively larger.

In FIG. 10(B) the relatively larger distance indicates an inkjet mechanism where the color K ink (e.g. black) includes a different type of ingredient from those of the other color inks. For example, the ink K may contain a dye and the other color inks may contain pigments. Further, the different ingredient (for example a dye) may be used for the other color inks. Further, the inkjet mechanism is not limited to jet inks containing pigments or dyes. The inkjet mechanism may be able to jet other types of ink containing an ingredient other than pigments and dyes.

When the dots of a black ink and the dots of the process black using color inks are shifted by a half of their dot pitch to form an image using the head unit 10 of FIG. 10, if they have a dot pitch of 150 dpi (dots per inch) arranged in the sub-scan direction for forming a single color, then a 300 dpi image can be formed by a single scan. Further, a 600 dpi image may be obtained by forming a 300 dpi image by a first scan and performing a second scan to interleave the pitch of the 300 dpi image.

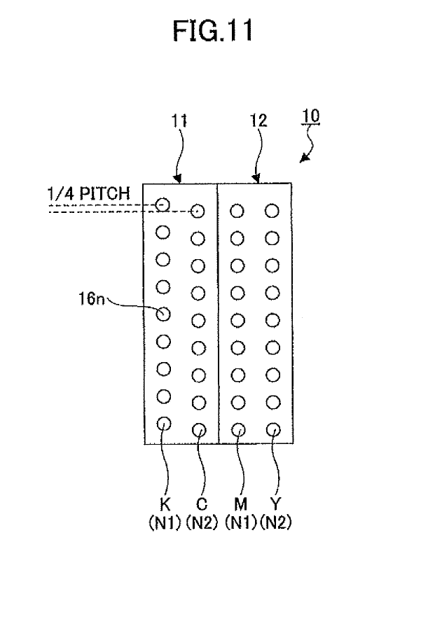

FIG. 11 is a second illustration showing an example of a head unit according to the present embodiment.

FIG. 11 shows another nozzle arrangement which is different from the nozzle arrangement shown in FIG. 10(A). A row K (N1) of the nozzles jetting black ink, is arranged to shift by a ¼ pixel pitch (¼ pitch) in the sub-scan direction from the other nozzle rows C, M, Y, which include plural color inks available to form black dots by mixing the plural colors.

For the head unit 10 shown in FIG. 11, when an image is recorded where the black dots of the black ink and the black dots of the process black formed by mixing color inks are relatively shifted by ¼ of their nozzle pitch, a 600 dpi image may be obtained by which a first scan image formed by 150 dpi nozzles of a consistent color is recorded by a second scan of 150 dpi nozzles to interleave the first scan. Likewise, a 1200 dpi image may be possible when a four scan recording is performed in the same manner.

Thus, for a serial head type, when the head unit 10 scans n times (n times transported by n times for the recording media 15) above the recording area having a width equal or less than the recording width of the head unit 10 in the sub-scan direction, the row shift between the nozzles jetting black ink and the nozzles jetting color inks in the sub-scan direction is set as a 1/n pixel pitch (n is an integer more than 2) or 1/(2n) pixel pitch (n is an integer more than 1) and the head unit 10 of the color inkjet recording apparatus 100 relatively scans plural times over the recording paper 15. In this manner, the image recording method of the embodiment of the present invention may be achieved.

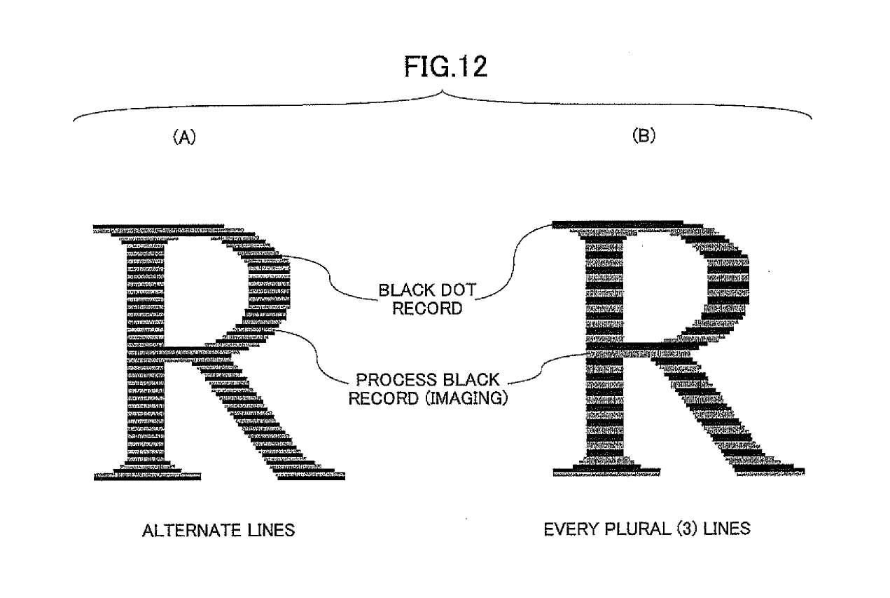

Further, FIG. 12 is an illustration showing an example of the recording position of black inks for a serial head method. When the head unit 10 is provided as shown in FIG. 10 or FIG. 11, lines formed by the black ink and the process black may be alternately recorded by a single line apart from other lines as shown in FIG. 12(A) or by plural lines apart (two lines apart from other lines, for example) as shown in FIG. 12(B).

Further, when the head unit 10 scans n times over the recording area less than the recording width of the head unit 10, all the nozzles may be used for printing or none of the nozzles may be used for printing according to the print control.

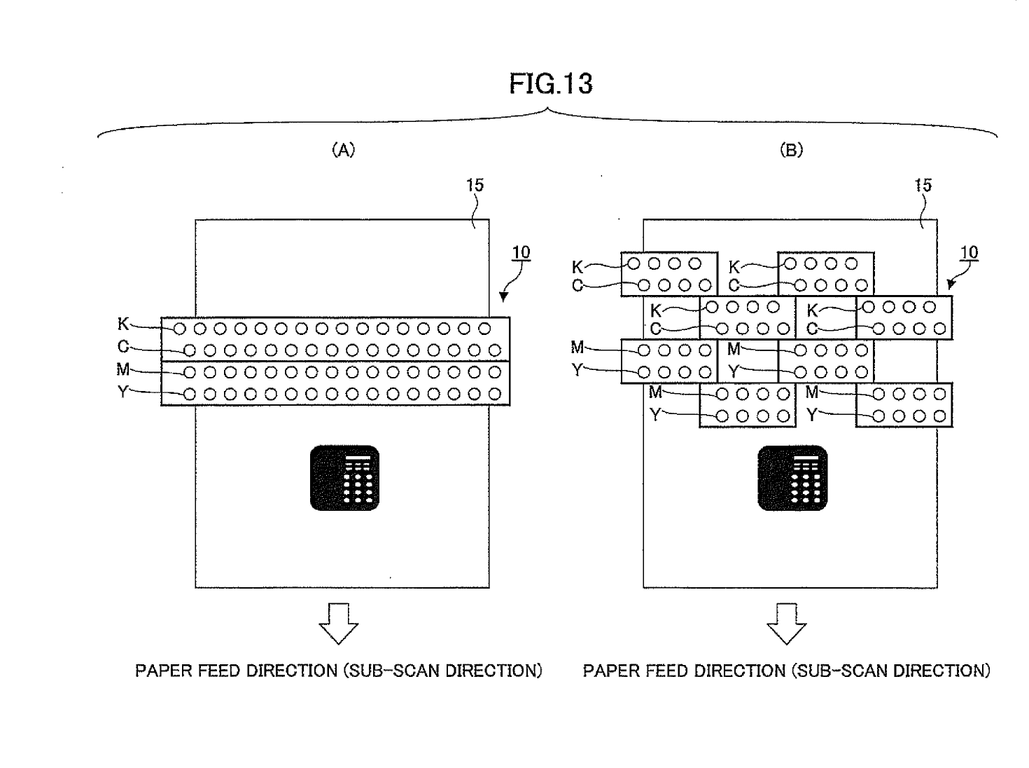

FIG. 13 is a third illustration showing an example of a head unit according to the present embodiment. In FIG, 13, a head unit 10 of a line head type is shown. FIG. 13(A) indicates an example showing long nozzle lines with colors arranged in the sub-scan direction. Further, FIG. 13(B) shows an example where plural recording heads with sizes similar to a serial head type are arranged in a staggered manner in the main-scan direction, and those are aligned in the sub-scan direction. The present embodiment according to the present invention includes such a head unit 10.

Further, as a shape of the color inkjet recording apparatus 100 using a line head type, the recording apparatus 100 may provide a conveyer mechanism transporting the recording paper 15 on the same level or provide a drum shaped conveyer mechanism that turns the recording paper 15.

Further, for the color inkjet recording apparatus 100 including the conveyer mechanism transporting the recording paper 15 in a plane, when the head unit 10 scans relative to the recording paper 15, a first single scan is basically performed. After the first scan, the recording paper 15 may be transported in the reverse direction, enabling a second scan and recording. In the same manner, plural scans and recordings may be possible.

Further, when the color inkjet recording apparatus 100 includes a drum-shaped conveyer unit providing a rotation mechanism for the recording paper 15, the color inkjet recording apparatus 100 can return the recording paper 15 to the start point of the first scan, and then plural scans and recordings can be easily performed.

For such a line head type color inkjet recording apparatus 100, nozzles of the head unit 10 capable of forming black dots by using a mixture of plural color inks are arranged in the paper feed direction (the sub-scan direction), and the row of the black ink nozzles is arranged shifted by a 1/n pixel pitch (n is an integer and equal to or greater than 2) relative to the rows of the plural color ink nozzles perpendicular (sub-scan direction) to the paper feed direction, so that the recording method and embodiment of the present invention may be achieved.

For the examples described in FIG. 10, FIG. 11, and FIG. 13, the nozzles jetting identical color inks are set at a 150 dpi pitch and the rows of the nozzles are arranged in the order of K, C, M, and Y. However, the colors, the order of colors, the number of colors and the nozzle pitch are not limited by the present example. Another order of the color inks or another unit having other colors, nozzles having less distance pitches may be used according to the characteristics of inks and the design choice.

Further, when the color inks provide the process black or the control, a monochrome image with high resolution and high concentration is formed by controlling the impact order of the color inks providing the process black and the amount of ink droplet when a monochrome printing mode is selected (monochrome printing is selected by a user).

Further, even if a color mode is selected, a monochrome image with high resolution and high concentration is formed for part of the monochrome data of print data (input image) by controlling the impact order of the color inks providing the process black and the amount of ink, as described above.

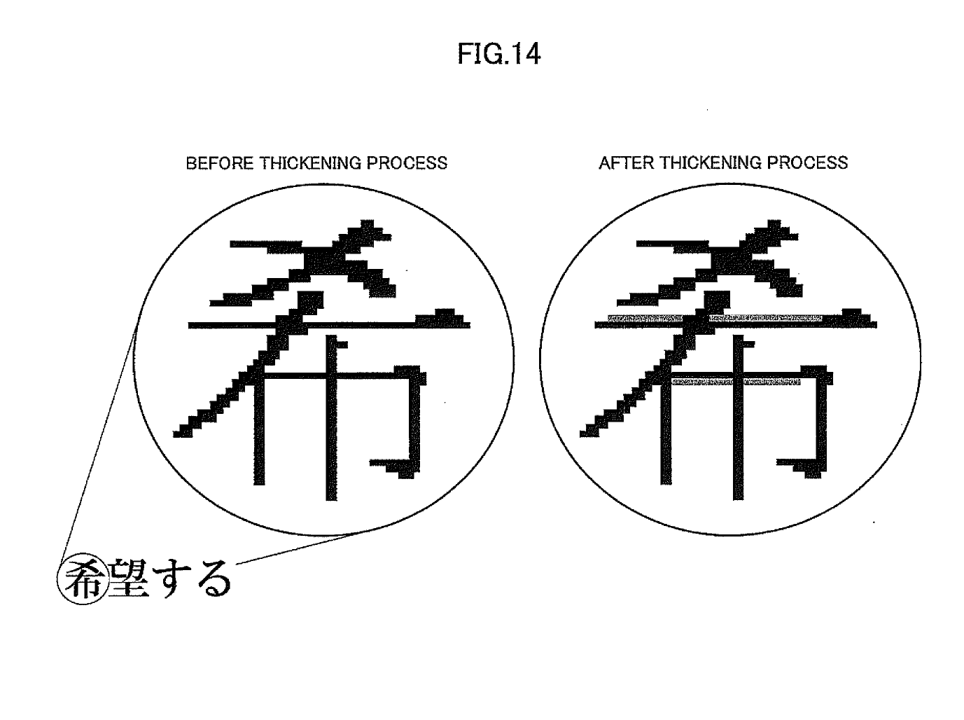

Further, for an image to be printed, a preliminary process, which adds at least one dot to an adjacent pixel next to a single dot thick fine line, may be performed. FIG. 14 is an illustration showing an example of the process adding a single dot to an adjacent pixel of a fine line with a single dot thickness. By performing such a process, the single dot thick fine line to be printed with only the process black, having lower concentration than the black ink, can be avoided, and a more proper black can be obtained.

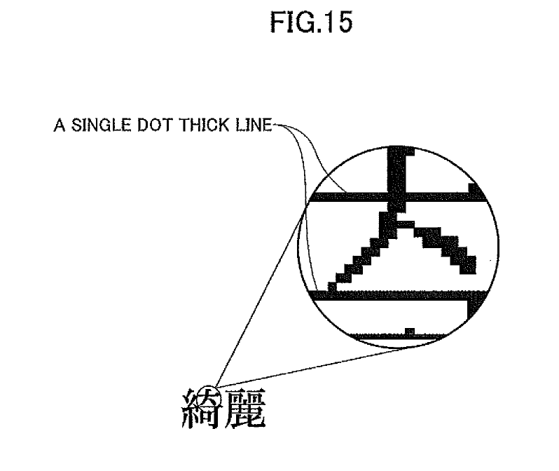

In this case, as shown in FIG. 15, the presence of a single dot thick fine line in a line to be printed may be determined based on input data (print data of an image of an object to be printed (printing information)) including information of the font, especially a type of the font, information of the font size and the like. For example, FIG. 15 shows a letter written in a font “Mincho type” with a size of “10.5 pt.” In this case, it is determined whether the letter is written by a single dot thick line or non-single dot thick line based on the information of “10.5 pt” and “Mincho type”.

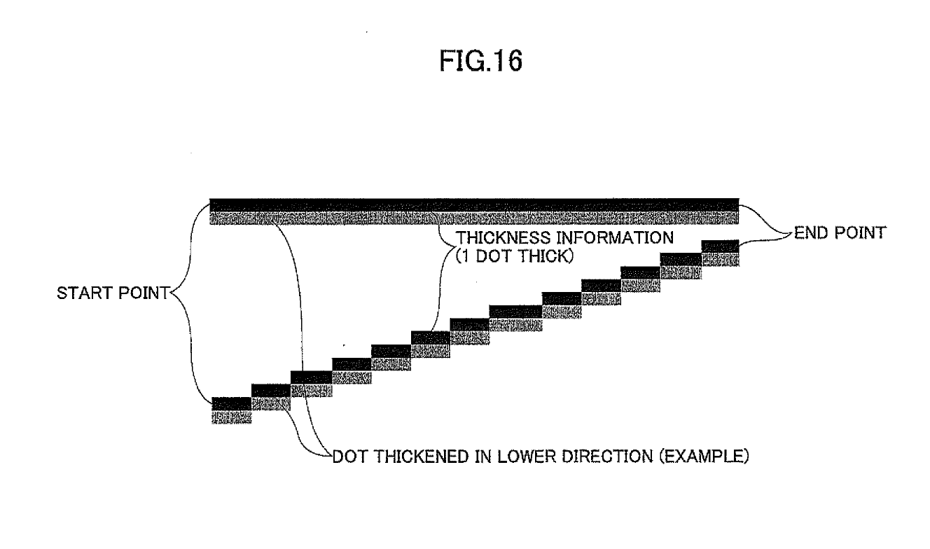

Further, as shown in FIG. 16, whether the letter is a single dot thick line or non-single dot thick line may be determined based on the information of the vector of a line (a line segment) included in the input data, especially based on the information of the start and end points of the line and the line thickness.

As described above, according to the present embodiment, a monochrome image or monochrome data can be recorded with high concentration and high resolution. The resolution of the input image (image to be printed) may need to be up-converted (higher resolution) or down-converted (lower resolution) in response to the monochrome image, the resolution of monochrome data, a color image or the resolution of color data of the head unit 10.

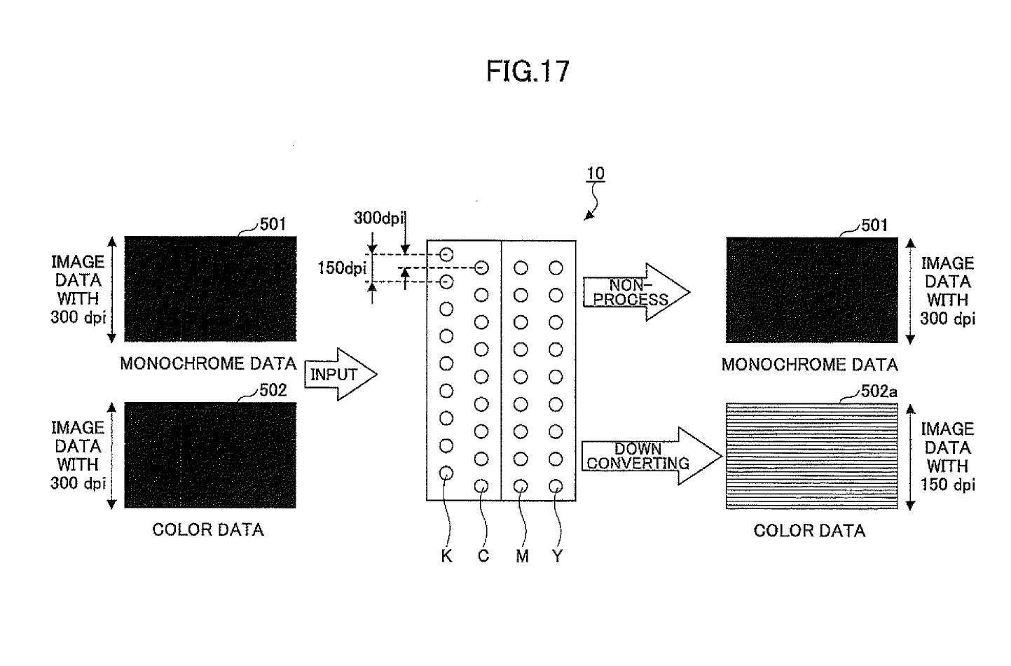

FIG. 17 shows an example of down-converting the resolution of an input image according to the recording resolution of a head unit 10. For the head unit 10 of FIG. 17, the nozzle pitch of each nozzle row is 150 dpi and there is an offset between the row of the nozzles K and the rows of the nozzles C, M, and Y by a half pitch (300 dpi). For the present case, when the head unit 10 prints with the process black and the black ink together, the recording resolution of a monochrome image is 300 dpi. On the other hand, the recording resolution of a color image is 150 dpi.

Down-converting is not performed for a monochrome image 501 at 300 dpi. On the other hand, down-converting is performed for a color image 502 at 300 dpi, resulting a color image 502a at 150 dpi corresponding to the color image recording resolution of the head unit 10. Further, down-converting may be achieved by extracting data from the input image to obtain a predetermined resolution as shown in FIG. 17 or by performing an image interpolation process such as a bicubic method, a nearest neighbor method or the like.

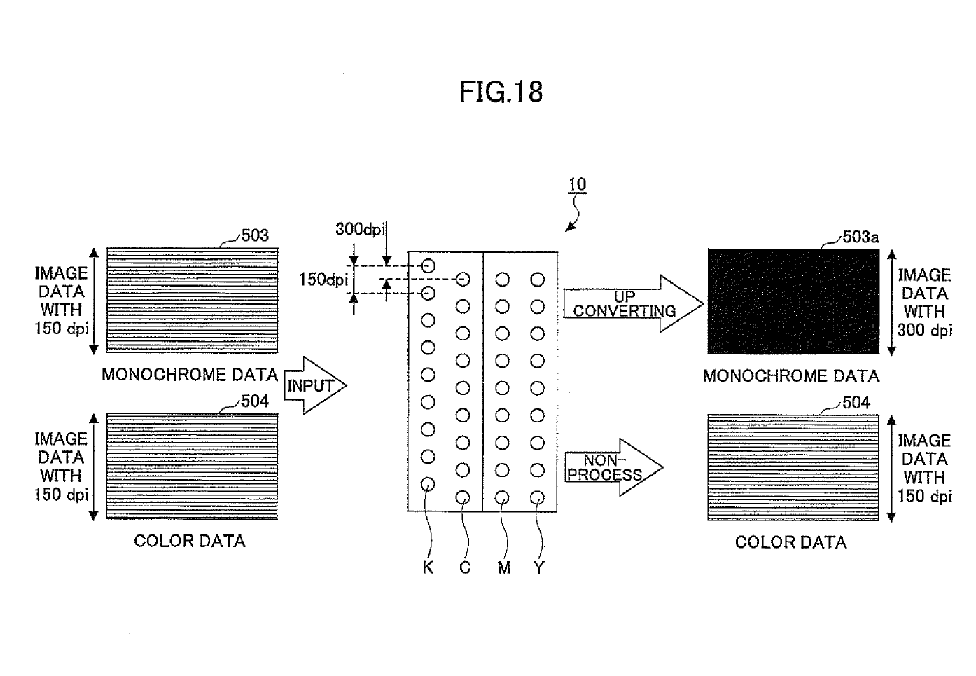

FIG. 18 shows an example of up-converting the resolution of an input image according to the recording resolution of a head unit 10. The configuration of the head unit 10 is the same as that of the head unit 10 of FIG. 17.

Up-converting is performed for a monochrome image 503 at 150 dpi, resulting in monochrome image 503a at 300 dpi corresponding to the monochrome image recording resolution of the head unit 10. On the other hand, up-converting is not performed for a color image 504 at 150 dpi. Further, up-converting to obtain a predetermined resolution may be performed by enlarging an input image or by performing the image interpolation process such as the bicubic method, the nearless neighbor method or the like.

Further, the above is described for a color inkjet recording apparatus 100 jetting liquid color inks as a typical example. The description is applicable for image forming apparatuses which include a jetting mechanism such as a piezoeffect of a piezoelectric element or a film boiling provided by a heating element generating heat by a current flow. The above description may be applicable for a line head type image forming apparatus as well as a serial head type image forming apparatus as described before.

Next, print control applicable to the embodiment of the present invention is described. A cross-control applied to an embodiment of the present invention is described here. The “cross-control” operates both a drive of the carriage 4, on which the head unit 10 is mounted, in the main-scan direction and a drive conveying the recording paper (record medium) 15 in the sub-scan (second) direction overlapped and synchronized. Ideally to increase the print speed, the timing is controlled so that the main-scan (CR) drive is started before the sub-scan (LF) is completed and LF is stopped at the time the CR arrives at a position to be recorded. If such time control were not performed, the CR would arrive at the position to be recorded while the LF is operating, causing oblique recording or wasting a CR drive period with no recording due to not synchronizing with the LF drive.

So far, the image forming method and image forming apparatus of the present embodiment have been described. However, the applicable range of the present invention is not limited to the present embodiment. For example, the image forming method described above may include one of a host computer (sending print data) requesting print data from an image forming apparatus and the image forming apparatus, and the host computer and the image forming apparatus or all of them may be integrated into a unit as an image forming system.

Further, the embodiment above may be constituted by the series of the image processes being performed by the CPU of a host computer or a part of or the entire series of the image processes being performed by the image forming apparatus.

Further, the present invention may be applicable to an embodiment of a computer readable record medium including the image forming method program. Further the computer readable record medium may include a printer driver installable into a computer.

An embodiment of a recording medium having a program and data to achieve the image forming process according to the present invention is next described. Specifically, a recording medium may include a CD-ROM, an optical-magnetic disc, a DVD-ROM, a FD, a flash memory, a memory card, a memory stick and other ROMs or RAMs. The steps of the embodiment of the present invention recorded on these recording media are executed by a computer, and a program to achieve the functions of the image forming method described above is recorded on these media and is distributed to the market place so that achieving the functions of the present embodiment becomes easier. Further, the recording medium above is mounted on an information processing apparatus such as a computer and the program of the medium is read by the information processing apparatus or the program is stored into a memory medium included in the information processing apparatus and is read by the information processing apparatus as required, so that the image forming method related to the present invention is executed.

As described above, for a color inkjet recording apparatus 100 according to the present embodiment, a gray balance of the process black becomes closer to an achromatic color by controlling at least one of the order of impact of color inks including the process black and the amount of the inks to become a higher concentration, and a monochrome (gray) image formed by the process black and the black dots achieves higher resolution and higher concentration.

The present invention is not limited to the specifically disclosed embodiments, and variations and modifications may be made without departing from the scope of the present invention.

The present application is based on Japanese Priority Application No. 2007-229440 filed on Sep. 4, 2007, the entire contents of which are hereby incorporated herein by reference.

What is claimed is:

1. An image forming method comprising the steps of:
(a) providing a plurality of first nozzles for depositing a black color ink and a plurality of second nozzles for depositing color inks other than a black color ink to form a processed black color, the first nozzles and the second nozzles being mounted on a recording head of an image forming apparatus scanning relative to a recording medium in a first direction, the first nozzles being shifted relative to the second nozzles in a second direction perpendicular to the first direction,
(b) scanning the recording head in the first direction for forming; and
(c) while scanning the recording head in the first direction once, for printing a black image, depositing the black color ink by the first nozzles onto a first recording position of the recording medium and depositing the color inks by the second nozzles to form the processed black color onto a second recording position of the recording medium so that the black color ink deposited onto the first recording position is shifted relative to the color inks deposited to form the processed black color onto the second recording position, wherein the order of depositing the color inks onto the second recording position is based on a predetermined index indicating a difference between the processed black color formed by the color inks and the black color of the black color ink or between the processed black color formed by the color inks and a reference achromatic color.

2. The image forming method as claimed in claim 1, wherein one ink of the second nozzles having a color closer to a black color of the black ink or closer to an achromatic color than other inks of the second nozzles based on the predetermined index is deposited on the second recording position in advance of the other inks while the recording head scans outwardly or inwardly in the first direction.

3. The image forming method as claimed in claim 1, wherein when a color of one ink of the second nozzles is farther from the black color of the black ink or farther from the achromatic color than other inks of the second nozzles based on the predetermined index, an amount of the one ink of the second nozzles is reduced relative to the other inks of the second nozzles.

4. The image forming method as claimed in claim 1, wherein one ink of the second nozzles having a black color concentration higher than other inks of the second nozzles is deposited on the second recording position in advance of the other inks of the second nozzles having lower black concentrations than the one ink.

5. The image forming method as claimed in claim 1, wherein one ink of the second nozzles having a color distance from the black color of the black ink or an achromatic color smaller than other inks of the second nozzles is deposited on the second recording position in advance of the other inks of the second nozzles.

6. The image forming method as claimed in claim 1, wherein the recording head deposits inks on the recording medium while scanning outward and inward in the first direction, one ink of the second nozzles having a color closer from the black color of the black ink or the achromatic color based on the predetermined index than other inks of the second nozzles is deposited in advance of the other inks of the second nozzles on the second recording position while the recording head scans outwardly in the first direction, and while the recording head scans inwardly in the first direction, the one ink of the second nozzles is deposited following the other inks of the second nozzles and the one ink is reduced to smaller amounts than the other inks deposited on the second recording position.

7. The image forming method as claimed in claim 6, wherein one ink of the second nozzles having a black concentration higher than other inks of the second nozzles is deposited on the second recording position in advance of the other inks while the recording head scans outwardly in the first direction.

8. The image forming method as claimed in claim 6, wherein one ink of the second nozzles having a color distance from the black color of the black ink or the achromatic color smaller than other inks of the second nozzles is deposited on the second recording position in advance of the other inks of the second nozzles while the recording head scans outwardly in the first direction.

9. The image forming method as claimed in claim 1, wherein the recording head has the first nozzles and the second nozzles shifted by 1/n pixel pitch (n is an integer equal to or larger than 2) relative to each other in the second direction, and the recording head scans n times a recording width of a recording area equal or less than the recording width of the recording head in the second direction and deposits inks on the first recording position and the second recording position.

10. The image forming method as claimed in claim 1, wherein the recording head has the first nozzles and the second nozzles shifted by ½n pixel pitch, wherein n is an integer equal to or larger than 1, relative to each other in the second direction, and the recording head scans a recording area n times having a recording width equal or less than the recording width of the recording head in the second direction and deposits inks on the first recording position and the second recording position.

11. The image forming method as claimed in claim 1, wherein when the recording head is requested to print a monochrome image, while the recording head scans once, a black ink is deposited on the first recording position by the first nozzle, and each ink of the second nozzles is deposited on the second recording position.

12. The image forming method as claimed in claim 1, wherein when the recording head is requested to print a color image, while the recording head scans once, for a monochrome part, the black ink of the first nozzle is deposited on the first recording position, and each ink of the second nozzles is deposited on the same second recording position.

13. The image forming method as claimed in claim 1, wherein an input image is thickened by one pixel in the second direction and the thickened input image is printed by the recording head.

14. The image forming method as claimed in claim 13, wherein for an input image it is determined whether a line of the input image is one pixel thick in the second direction according to font information or vector information of the input image.

15. The image forming method as claimed in claim 1, wherein when a resolution of an input image is different from the resolution of the recording head using both the first nozzle and the second nozzles, the resolution of the input image is adjusted to the resolution of the recording head.

16. An image forming apparatus comprising:
a first nozzle for depositing a black color ink;
a set of second nozzles for depositing plural color inks other than the black color ink to form a processed black color;
a recording head including the first nozzle and the second nozzles and scanning in a first direction; and
the first nozzle and the second nozzles being shifted relative to each other in a second direction perpendicular to the first direction;
wherein for printing a black image, while the recording head scans once in the first direction, the black color ink is deposited on a first recording position of a recording medium by the first recording nozzle and each color of the second nozzles is deposited on a second recording position of the recording medium to form the processed black color by the corresponding second nozzles, wherein the order of depositing the inks of the second nozzles is determined based on a predetermined index indicating a difference between the processed black color formed by the color inks and the black color of the black color ink or between the processed black color formed by the color inks and a reference achromatic color.

17. A computer-readable recording medium having instructions executable by a computer according to the image forming method as claimed in claim 1.
